(19) United States
(12) Patent Application Publication
(10) Pub. No.: US 2014/0046752 A1
(43) Pub. Date: Feb. 13, 2014

(54) ASSESSING ADVERTISEMENT IMPACT USING ADVERTISEMENT READABLE INDICIA

(71) Applicants: Peter John Bertanzetti, Charlotte, NC (US); David M. Grigg, Rock Hill, SC (US); Susan Smith Thomas, Gastonia, NC (US); Matthew A. Calman, Charlotte, NC (US)

(72) Inventors: Peter John Bertanzetti, Charlotte, NC (US); David M. Grigg, Rock Hill, SC (US); Susan Smith Thomas, Gastonia, NC (US); Matthew A. Calman, Charlotte, NC (US)

(73) Assignee: Bank of America Corporation, Charlotte, NC (US)

(21) Appl. No.: 13/572,311

(22) Filed: Aug. 10, 2012

(51) Int. Cl. G06Q 30/02; G06Q 90/00

(52) U.S. Cl. 705/14.41; 235/375

(57) ABSTRACT

Embodiments of the invention are directed to systems, methods and computer program products for processing a readable indicia associated with an advertisement associated with a product. The invention presents a readable indicia in association with an advertisement, where the readable indicia includes instructions for triggering a data collection tool. The invention collects data from the data collection tool and analyzes characteristics of the readable indicia and the advertisement in order to determine a customer advertisement impact. The readable indicia may include information indicating at least one of a current date, a time of inception of the advertisement, a placement location of the readable indicia within the advertisement, or a visual characteristic of the readable indicia.

### BACKGROUND

Sometimes, a user viewing an advertisement wants more information about a product or to purchase the product. There is a need to enable the user to gain access to additional information and purchase the product more easily.

### BRIEF SUMMARY

Embodiments of the invention are directed to systems, methods and computer program products for processing a readable indicia associated with an advertisement associated with a product.

According to some embodiments, an apparatus, the apparatus includes a memory; a processor; and a computing module stored in the memory, executable by the processor, and configured to cause the processor to An apparatus for processing a readable indicia associated with an advertisement associated with a product. The apparatus includes a memory; a processor; and a computing module stored in the memory, executable by the processor, and configured to cause the processor to present a readable indicia in association with an advertisement, wherein the readable indicia includes instructions for triggering a data collection tool; collect data from the data collection tool; and analyze characteristics of the readable indicia and the advertisement in order to determine a customer advertisement impact.

In some embodiments, the readable indicia comprises a Quick Response (QR) code.

In some embodiments, the readable indicia comprises a variable readable indicia. In some such embodiments, the variable readable indicia includes data indicating at least one of a current date, a current time, a placement location of the readable indicia within the advertisement, a visual characteristic of the readable indicia, or a time elapsed since inception of the advertisement.

In some embodiments, the readable indicia comprises data indicating at least one of a current date, a time of inception of the advertisement, a placement location of the readable indicia within the advertisement, or a visual characteristic of the readable indicia. In some embodiments, the computing module is further configured to cause the processor to determine a value of a characteristic that maximizes user selection of the readable indicia. In some embodiments, the computing module is further configured to cause the processor to determine a combination of values of a plurality of characteristics that maximize user selection of the readable indicia. In some embodiments, the readable indicia comprises a vanishing readable indicia that presents a continuously diminishing time remaining communication, wherein when the time remaining communication reaches zero, the vanishing readable indicia is removed from the advertisement.

According to embodiments of the invention, a method for processing a readable indicia associated with an advertisement associated with a product includes providing a processor for executing computer program code stored in a non-transitory computer-readable medium to cause the processor to present a readable indicia in association with an advertisement, wherein the readable indicia includes instructions for triggering a data collection tool; collect data from the data collection tool; and analyze characteristics of the readable indicia and the advertisement in order to determine a customer advertisement impact.

In some embodiments, the readable indicia comprises a Quick Response (QR) code.

In some embodiments, the readable indicia comprises a variable readable indicia. In some such embodiments, the variable readable indicia comprises data indicating at least one of a current date, a current time, a placement location of the readable indicia within the advertisement, a visual characteristic of the readable indicia, or a time elapsed since inception of the advertisement.

In some embodiments, the readable indicia comprises data indicating at least one of a current date, a time of inception of the advertisement, a placement location of the readable indicia within the advertisement, or a visual characteristic of the readable indicia. In some embodiments, the computing program code is further to cause the processor to determine a value of a characteristic that maximizes user selection of the readable indicia. In some embodiments, the computing program code is further to cause the processor to determine a combination of values of a plurality of characteristics that maximize user selection of the readable indicia. In some embodiments, the readable indicia comprises a vanishing readable indicia that presents a continuously diminishing time remaining communication, wherein when the time remaining communication reaches zero, the vanishing readable indicia is removed from the advertisement.

According to embodiments of the invention, a computer program product for processing readable indicia for a payment claim includes a non-transitory computer-readable medium comprising a set of codes for causing a computer to present a readable indicia in association with an advertisement, wherein the readable indicia includes instructions for triggering a data collection tool; collect data from the data collection tool; and analyze characteristics of the readable indicia and the advertisement in order to determine a customer advertisement impact.

In some embodiments, the readable indicia comprises a Quick Response (QR) code.

In some embodiments, the readable indicia comprises a variable readable indicia. In some such embodiments, the variable readable indicia comprises data indicating at least one of a current date, a current time, a placement location of the readable indicia within the advertisement, a visual characteristic of the readable indicia, or a time elapsed since inception of the advertisement.

In some embodiments, the readable indicia comprises data indicating at least one of a current date, a time of inception of the advertisement, a placement location of the readable indicia within the advertisement, or a visual characteristic of the readable indicia. In some embodiments, the set of codes is further for causing the computer to determine a value of a characteristic that maximizes user selection of the readable indicia. In some embodiments, the set of codes is further for causing the computer to determine a combination of values of a plurality of characteristics that maximize user selection of the readable indicia. In some embodiments, the readable indicia comprises a vanishing readable indicia that presents a continuously diminishing time remaining communication, wherein when the time remaining communication reaches zero, the vanishing readable indicia is removed from the advertisement.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing a readable indicia associated with an advertisement associated with a product in accordance with embodiments of the present invention;

FIG. 2 is a block diagram illustrating technical components of a system for processing a readable indicia associated with an advertisement associated with a product in accordance with embodiments of the present invention;

FIG. 3 is a flowchart illustrating a general process flow for processing a readable indicia associated with an advertisement associated with a product in accordance with embodiments of the present invention;

FIG. 4 is a flowchart illustrating a general process flow for processing a readable indicia associated with an advertisement associated with a product in accordance with embodiments of the present invention; and

FIG. 5 is a flowchart illustrating a general process flow for processing a readable indicia associated with an advertisement associated with a product in accordance with embodiments of the present invention.

### DETAILED DESCRIPTION OF EMBODIMENTS OF THE INVENTION

Embodiments of the invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for processing a readable indicia associated with an advertisement associated with a product. The invention provides ease in communicating additional information to a user interested in a product associated with an advertisement as well as enabling the user to purchase the product immediately or providing the user an opportunity to purchase the product more easily at a later time. A product, as used herein, refers to services and/or goods offered for sale.

The invention decodes the readable indicia to determine product purchase information, wherein the product purchase information is associated with the product, receives authentication credentials associated with a payment account, and processes the authentication credentials to authorize a payment associated with the product purchase information. In some embodiments, the invention extracts a link from the readable indicia or a second readable indicia associated with the advertisement and initiates a user interface associated with the link. In some embodiments, the invention populates some or all the product purchase information into at least one of a user's notes, calendar or budget, and in some, the advertisement is placed proximate the product within a merchant's business and the invention initiates communication to a point of sale of the business indicating that the product has been purchased and receives a verification token configured for presentation at the point of sale for verifying that the product has been purchased.

As used herein, the readable indicia typically includes a code (e.g., a one dimensional code such as a barcode, a two dimensional code such as a Quick Response (QR) code, etc.). In some embodiments, the readable indicia includes visual indicia, e.g., a barcode, a Quick Response (QR) code, etc. The readable indicia may include any one-dimensional or two-dimensional code. The invention is not limited to the merchant being an insurance entity. In embodiments where the readable indicia is in electronic form, the readable indicia may be dynamically generated after the user selects an option to view the readable indicia (e.g., on the user's portable mobile communication device). The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, etc.).

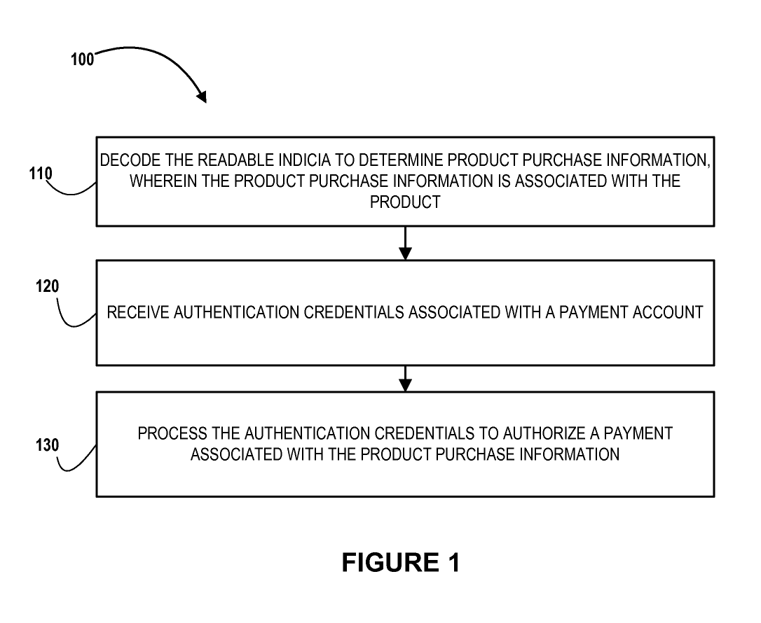

Referring now to FIG. 1, a general process flow 100 is provided for processing a readable indicia associated with an advertisement associated with a product. An advertisement may be or include media displayed electronically, such as an advertisement on a display such as a television screen, computer display, tablet display, mobile device display or otherwise, or may be a printed advertisement such as a poster and may be a moving advertisement such as an audio-video advertisement or may be a still advertisement such as a page or part of a page of an Internet website or a page or part of a page of a printed document such as a newspaper or poster.

The readable indicia may be part of the advertisement, that is, it may be embedded within the advertisement or, in the event of a moving advertisement like a video advertisement, the readable indicia may be presented, completely before, partially before, during, partially after, completely after the advertisement or some combination of these.

A user may use a portable mobile communication device or apparatus (“mobile device”) that may include an image-capturing component (e.g., a camera) to capture the image of the readable indicia. In some embodiments, image of the readable indicia is stored in the mobile device. In other embodiments, the image of the readable indicia is automatically transmitted to an external server. In some embodiments, a user may bring a mobile device in close proximity to a readable indicia having a tag in order to receive information (e.g., readable indicia) associated with the tag.

At block 110, the readable indicia is decoded to determine product purchase information. In some embodiments, the readable indicia may be processed by at least one of the mobile device or the external server to decode the readable indicia and thereby determine product purchase information. The product purchase information, in various embodiments, may include all the information necessary for a mobile wallet of the user's mobile device to make a payment, for example, to make a purchase of a product associated with the advertisement. In some embodiments, the product purchase information includes one or more of product identification, merchant (or seller) identification, receiving account or receiving alias information (such as account number, routing number or other information necessary to credit a payment to the account/alias), product price and/or the like.

In some embodiments, the payment may be a payment from a first user to a second user. The first user may present readable indicia on the first user's mobile device or may issue readable indicia to the second user on a physical medium (e.g., paper) that also has an advertisement associated with a product. The readable indicia may represent a payment of an amount of funds. The second user may receive information associated with the presented readable indicia using the second user's portable mobile communication device.

At block 120, authentication credentials associated with a payment account are received from the user and/or retrieved/received from a memory of the user's mobile device or otherwise. In some embodiments, in response to receiving the readable indicia, the mobile device initiates an authentication prompt (e.g., at the link described above) for receiving the authentication credentials from the user. For example, the authentication prompt may include a prompt or challenge question for which the user knows the answer. These authentication credentials may have been previously received by the user from the merchant separately from the readable indicia. For example, the merchant or the financial institution managing the payment account may have sent a personal identification number (“PIN”) code to the user via mail, email, text or multimedia message, etc. As a further example, the user may have previously logged onto the merchant and/or financial institution's website in order to set up authentication credentials for the making payments to the merchant or by using the mobile wallet provided by the user's financial institution.

Subsequently, the user inputs authentication credentials onto a user interface of the mobile device. In some embodiments, this input may include entering a password. In some embodiments, this input may include entering an alias. For example, the alias may include a phone number, email address, or social networking identification information associated with the user. In other embodiments, this input may include entering an answer to a question. In still other embodiments, this input may include selecting a picture. In some embodiments, the received authentication credentials are stored in the mobile device. In other embodiments, the received authentication credentials are automatically transmitted to an external server.

In other embodiments, the user has previously entered any necessary authentication credentials into the mobile device and is therefore considered authenticated without further authentication being necessary. In some instances, some authentication has been performed prior to an attempted transaction and a confirmatory authentication may be required in order to complete a transaction. For example, the user may have already submitted a username and password for partial authentication to occur, but in order to complete a purchase transaction using the mobile device mobile wallet, the user must then enter a PIN to compete authentication.

In some embodiments, where no additional authentication is required, the user may scan the readable indicia associated with an advertisement and the mobile wallet automatically completes the transaction for purchasing the product associated with the advertisement.

At block 130, the authentication credentials are processed to authorize or initiate a payment associated with the product in the advertisement. In embodiments where the authentication credentials (and/or the readable indicia and/or an image thereof) are stored in the mobile device, the processing of the authentication credentials (and/or the readable indicia and/or an image thereof) occurs in the mobile device. In embodiments where the authentication credentials (and/or the readable indicia and/or an image thereof) are transmitted to an external server, the processing of the authentication credentials occurs outside the mobile device, i.e., at the external server. The processing may include comparing the authentication credentials (and/or information associated with the readable indicia) to information stored in at least one of the mobile device or the external server to determine whether to initiate issuance of a payment associated with the payment claim.

In some embodiments, authentication credentials are included in the readable indicia. During processing, the authentication credentials input by the user may be compared to the authentication credentials extracted from the readable indicia. In other embodiments, the authentication credentials are not included in the readable indicia. In such embodiments, the authentication credentials input by the user are compared to information (e.g., authentication credentials) stored in at least one of the mobile device or external server or accessed by at least one of the mobile device or external server from an external datastore. For example, in some embodiments, the user's mobile wallet has authentication credentials associated with it and stored in the mobile device such that when the user desires to make a transaction, the authentication credentials entered by the user may be compared to the authentication credentials stored in the mobile device.

If the mobile device or the external server determines a match between the authentication credentials input by the user and the authentication credentials either extracted from the readable indicia or stored in at least one of the mobile device or external server, the payment associated with the product of the advertisement is authorized or initiated for debiting the appropriate account associated with the mobile wallet and crediting the appropriate payment account of the merchant/business selling the produce associated with the advertisement. Therefore, the payment may be automatically transmitted to a payment account (e.g., a pre-selected financial institution account) associated with the merchant/business from the user's payment account. In alternate embodiments, the payment associated with the product is authorized or initiated without executing the authentication step described herein. In some embodiments, prior to enabling the user to select an account or input account information, one or more mobile interface pages of advertisements or additional information may be presented to the user. In some embodiments, the link(s) (e.g., a hyperlink) to such information may be included in the readable indicia or may be decoded from a separate readable indicia also associated with the advertisement. The user interface of the mobile device may present the link and may prompt the user to visit the link. The link may transport the user to a user interface page for entering authentication credentials. Prior to enabling the user to enter the authentication credentials, one or more mobile interface pages of advertisements may be presented to the user. Alternatively, information regarding the product may be presented to the user without initiating a payment for the product. Such information and/or links may be stored in the mobile device or elsewhere for the user to access the information at a later time.

In some embodiments, after the user authenticates himself or herself, the payment for the product may be made to an alias that was provided by the readable indicia (as opposed to necessary account/routing numbers). Accordingly, the payment may then be processed by the financial institution managing the merchant/business's receiving account such in order to enhance privacy of the merchant's sensitive information, e.g., account numbers. For example, when the mobile wallet sends the payment to an alias, the financial institution of the merchant receives the payment, interprets the alias, and forwards the payment to the merchant's account. Therefore, the merchant receives the payment without providing the merchant's account information to the user or the user's mobile device.

Similarly, when a payment is being made from the user's mobile wallet, the mobile wallet may provide an alias to the user's financial institution, which may then properly debit an account associated with the alias. In this regard, the user's sensitive information, i.e., account numbers, may remain private.

In various embodiments, the readable indicia or a second readable indicia includes instructions to populate some or all the product purchase information or other information about the product into at least one of the user's electronic notes, calendar and/or budget. For example, in some embodiments, there is a readable indicia that includes a link to additional information as well as a second readable indicia that includes instructions for populating. In some embodiments, there is just one readable indicia that includes both one or more links and instructions for populating. In some embodiments, there is one readable indicia that includes product purchase information and may be used to initiate the purchase of the product, and in the event that the user cancels the purchase before it is completed, instructions for populating information regarding the product are also included in the readable indicia so that the user may choose to consider the product and its purchase at a later time. In some embodiments where the product purchase information is stored on the mobile device, such as by populating as discussed above, when the user subsequently makes a purchase decision, the stored product purchase information may be used as discussed above to purchase the product easily.

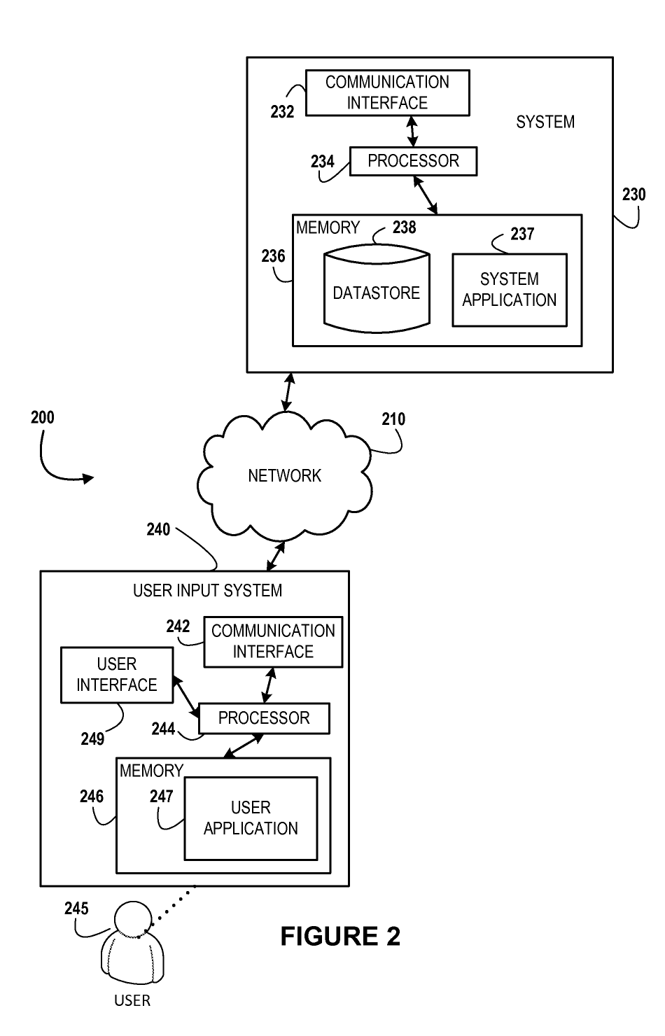

Referring now to FIG. 2, an exemplary block diagram of the system environment 200 for implementing the process flow 100 described in FIG. 1 (and/or the other process flows described herein) is shown, in accordance with embodiments of the invention. As illustrated, the system environment 200 includes a network 210, a system 230, and a user input system 240. Also shown in FIG. 2 is a user 245 of the user input system 240. The user input system 240 may be a mobile device as described herein. The user 245 may be a person who uses the user input system 240 to execute a user application 247. The system 230 may be the external server described herein. The user application 247 and/or the system application 237 may incorporate one or more parts of the process flow 100 or any other function described herein.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that some or all the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system (such as one or more servers maintained by a financial institution), a personal computer system, and/or the like. Therefore, the system 230 may be an external server as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, etc.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein. As another example, the system 230 may represent one or more financial institutions and/or one or more financial institution systems and/or servers. In some embodiments, one financial institution communicates with another financial institution across the network 210 and/or some other network or networks, for example, in order to process transactions such as payments for products.

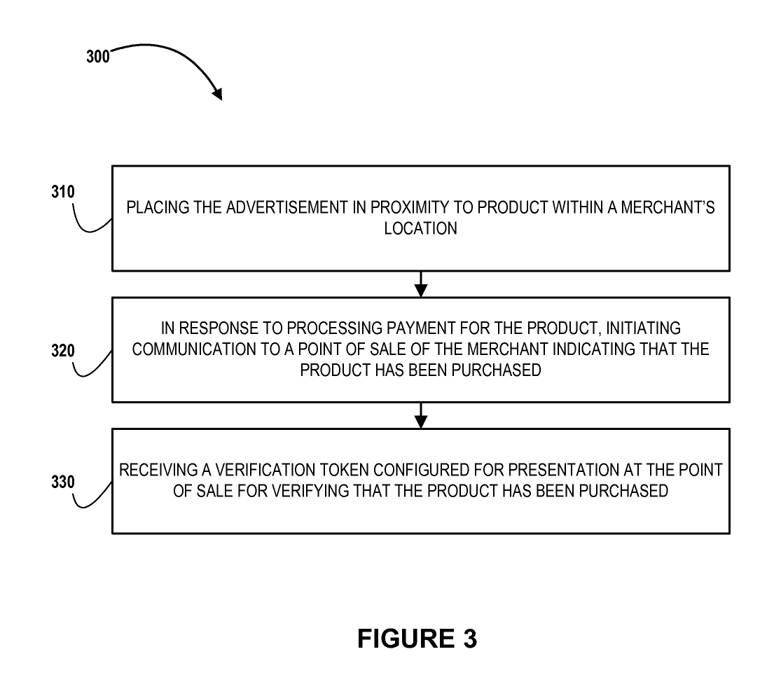

Referring now to FIG. 3, a general process flow 300 is provided for processing a readable indicia associated with an advertisement associated with a product according to other embodiments of the invention. At block 310, a merchant may present an advertisement in close proximity to a product or otherwise placing the advertisement in a retail location for presentation to potential customers. For example, in the case of the product being services, the advertisement may not need be placed proximate, for example, an item in a retail location, but rather, may constitution an advertisement for services and may include a readable indicia embedded thereon. Thus, in some embodiments, the product is placed proximate the advertisement or such that the advertisement is placed in an optimized location to drive customers to consider the product and purchase the product.

At block 320, in response to processing payment for the product (see step 130), the mobile device or the external server may initiate communication to a point of sale of the merchant indicating that the product has been purchased. In some embodiments, this communication may be initiated directly from the mobile device over a wireless network within the location to the point of sale of the location. In other embodiments, the communication may be initiated from the mobile device over a larger network and through the Internet to the point of sale of the merchant. In some such embodiments, the readable indicia includes information indicating an identity of the location so that the mobile device may be able to communication with the proper point of sale. In some such embodiments, the readable indicia may include instructions for communicating directly between the mobile device and the point of sale or otherwise communicating the product purchase to the point of sale. In this way, the merchant may become aware of the purchase so that, when the user carries the product through a checkout line, for example, the clerk may recognize that the user has, in fact, already made the purchase. This may be performed by the mobile device receiving a verification token configured for presentation at the point of sale for verifying that the product has been purchased, as represented by block 330. The communication of the token, which may be an electronic receipt and/or readable indicia, may be performed electronically to the mobile device, such as via some type of wireless communication. Then, the user may present the token or receipt at the point of sale for verification. This may be done visually, electronically (e.g., wirelessly) or otherwise.

In various embodiments of the invention, an advertisement may solicit a donation, such as for a charitable organization. Thus, the readable indicia may include information related to the charity, a link to more information about the charity, or may offer a “donate now” functionality for the charity, which operates similarly to the product purchase processes discussed above.

In various embodiments, the readable indicia allows the user to pay for a product purchase at a later date. For example, the user may take the product out of the merchant location after effectively performing a transaction using the readable indicia of an advertisement proximate the product where the transaction obligates the user to pay for the product at a later date. In some embodiments, the payment for the product may be set up to automatically occur without further action from the user.

In some embodiments, the user may establish monthly or otherwise occurring payments for the purchase of a product or donation using the invention. Alternatively, in some embodiments, the invention offers the user an option to receive an invoice for payment, either in hard copy or electronically.

In some embodiments, the user is given an opportunity to register the serial number of the product purchased using the interface of the mobile device. The mobile device/mobile wallet of the user may have access to some or all the user's personal information necessary to submit documentation for registering for a warranty or some other product registration. The registration may be performed automatically based on information decoded from the readable indicia or another readable indicia presented on the product or its packaging.

In various embodiments, additional readable indicia may be provided in associated with an advertisement. For example, in some embodiments, a readable indicia may be configured for purchasing now, another may be configured for more information, another may be configured for calendaring or otherwise storing information regarding the advertisement/product, and/or another may be configured for other functionality.

In summary, embodiments of the invention are directed to systems, methods and computer program products for processing a readable indicia associated with an advertisement associated with a product. The invention provides ease in communicating additional information to a user interested in a product associated with an advertisement as well as enabling the user to purchase the product immediately or providing the user an opportunity to purchase the product more easily at a later time. The invention decodes the readable indicia to determine product purchase information, wherein the product purchase information is associated with the product, receives authentication credentials associated with a payment account, and processes the authentication credentials to authorize a payment associated with the product purchase information. In some embodiments, the invention extracts a link from the readable indicia or a second readable indicia associated with the advertisement and initiates a user interface associated with the link. In some embodiments, the invention populates some or all the product purchase information into at least one of a user's notes, calendar or budget, and in some, the advertisement is placed proximate the product within a merchant's business and the invention initiates communication to a point of sale of the business indicating that the product has been purchased and receives a verification token configured for presentation at the point of sale for verifying that the product has been purchased.

In various other embodiments of the invention, the advertising impact of using advertisement readable indicia may be determined.

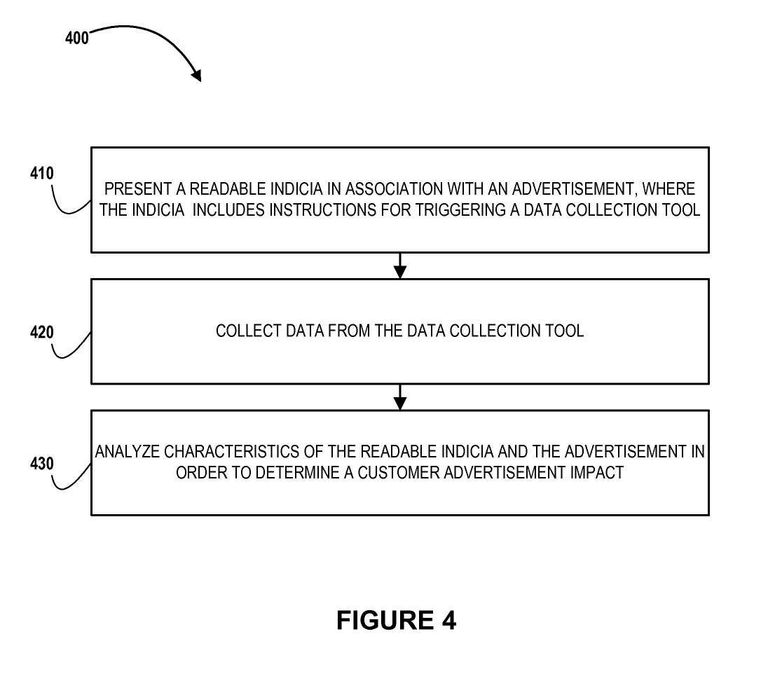

Referring now to FIG. 4, a general process flow 400 is provided for processing a readable indicia associated with an advertisement associated with a product according to other embodiments of the invention. At block 410 a readable indicia is presented in association with an advertisement, such as a video advertisement, web advertisement or the like. The readable indicia includes instructions for triggering a data collection tool. For example, the readable indicia may include a network address for a website, computer or otherwise, that includes a tool for collecting data regarding a user's selection of the readable indicia from the advertisement. At block 420, the data collection tool collects data from the mobile device that has selected the readable indicia. In some embodiments, the readable indicia includes instructions for providing data from the mobile device to the data collection tool. In other embodiments, the data collection tool collects data regarding the mobile device itself or some combination of the two. This data may then be communicated to another server for analysis or may be analyzed at the system(s) running the data collection tool.

At block 430, characteristics of the readable indicia, the advertisement and/or the mobile device are analyzed in order to determine a customer advertisement impact. For example, the placement of the indicia within the advertisement may be tracked by the readable indicia itself, for example, if the readable indicia, is moving around within the advertisement. This type of variable readable indicia may include information regarding these characteristics, such as location, timing, such as timing from the start of the advertisement or timing from the time of presentation of the readable indicia in the advertisement, or timing in association with the timing of happenings within the advertisement (e.g., when the product is first shown to the viewer, etc.).

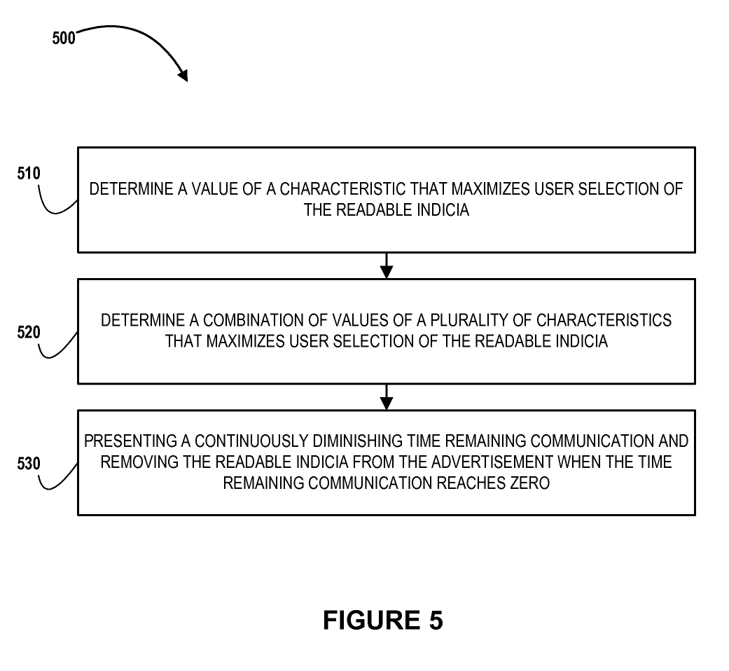

Referring now to FIG. 5, a general process flow 500 is provided for processing a readable indicia associated with an advertisement associated with a product according to other embodiments of the invention. At block 510, a value of a characteristic associated with the selection of the readable indicia by the user may be determined. Once multiple values of the particular characteristic have been gathered, the characteristic may be analyzed such that the value of the characteristic that maximizes user selection of the readable indicia may be determined. In some embodiments, multiple characteristics may be analyzed. For example, values for two characteristics, such as location of the readable indicia within the advertisement as well as time from the presentation of the readable indicia to selection of the readable indicia may be gathered for multiple selections and/or non-selections of the readable indicia. Thus, an analysis may be conducted to determine the maximum user indicia selection for particular combinations of values of the multiple characteristics of the readable indicia and/or the advertisement and/or the mobile device, as represented by block 520.

At block 530, another step that may be included in some embodiments of the invention is illustrated. A continuously diminishing time remaining communication, for example, a graphic of a clock counting down, may be presented to the viewer. When the time remaining communication reaches zero, the readable indicia may be modified or removed. In this regard, in some embodiments, the readable indicia may be considered a “vanishing” readable indicia.

In some embodiments, the invention determines the physical location of the mobile device of the user when the readable indicia is selected, and this information is collected by the data collection tool. This characteristic may be used during the analysis to assist in determining maximum impact of the advertising. For example, the system may be able to determine what physical locations of mobile devices are more likely to result in readable indicia selections.

In some embodiments, the system also takes into account weather or other environmental characteristics in determining the impact of advertising. For example, the local weather may be determined using the mobile device by accessing a weather database or application or directly determining the temperature or other weather characteristic and then that data is collected by the data collection tool and used by the system to determine what weather conditions may result in maximum user selections of readable indicia. Other potential data inputs to the system include the user's excitement level, based on user input or on physiological sensing equipment within the mobile device, the movement of the device including direction and/or speed of the device, as well as the time elapsed between presentation of the readable indicia and the user's selection of the readable indicia.

In the various embodiments, one, several or all of the inputs discussed herein may be used to analyze the user selection of readable indicia associated with advertisements in order to maximize the user selection.

In summary, some embodiments of the invention are directed to systems, methods and computer program products for processing a readable indicia associated with an advertisement associated with a product. The invention presents a readable indicia in association with an advertisement, where the readable indicia includes instructions for triggering a data collection tool. The invention collects data from the data collection tool and analyzes characteristics of the readable indicia and the advertisement in order to determine a customer advertisement impact. The readable indicia may include information indicating at least one of a current date, a time of inception of the advertisement, a placement location of the readable indicia within the advertisement, or a visual characteristic of the readable indicia.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for processing a readable indicia associated with an advertisement associated with a product, the apparatus comprising:
a memory;
a processor; and
a computing module stored in the memory, executable by the processor, and configured to cause the processor to:
present a readable indicia in association with an advertisement, wherein the readable indicia includes instructions for triggering a data collection tool;
collect data from the data collection tool; and
analyze characteristics of the readable indicia and the advertisement in order to determine a customer advertisement impact.

2. The apparatus of claim 1, wherein the readable indicia comprises a Quick Response (QR) code.

3. The apparatus of claim 1, wherein the readable indicia comprises a variable readable indicia.

4. The apparatus of claim 3, wherein the variable readable indicia comprises data indicating at least one of a current date, a current time, a placement location of the readable indicia within the advertisement, a visual characteristic of the readable indicia, or a time elapsed since inception of the advertisement.

5. The apparatus of claim 1, wherein the readable indicia comprises data indicating at least one of a current date, a time of inception of the advertisement, a placement location of the readable indicia within the advertisement, or a visual characteristic of the readable indicia.

6. The apparatus of claim 1, wherein the computing module is further configured to cause the processor to determine a value of a characteristic that maximizes user selection of the readable indicia.

7. The apparatus of claim 1, wherein the computing module is further configured to cause the processor to determine a combination of values of a plurality of characteristics that maximize user selection of the readable indicia.

8. The apparatus of claim 1, wherein the readable indicia comprises a vanishing readable indicia that presents a continuously diminishing time remaining communication, wherein when the time remaining communication reaches zero, the vanishing readable indicia is removed from the advertisement.

9. A method for processing a readable indicia associated with an advertisement associated with a product, the method comprising:
providing a processor for executing computer program code stored in a non-transitory computer-readable medium to cause the processor to:
present a readable indicia in association with an advertisement, wherein the readable indicia includes instructions for triggering a data collection tool;
collect data from the data collection tool; and
analyze characteristics of the readable indicia and the advertisement in order to determine a customer advertisement impact.

10. The method of claim 9, wherein the readable indicia comprises a Quick Response (QR) code.

11. The method of claim 9, wherein the readable indicia comprises a variable readable indicia.

12. The method of claim 11, wherein the variable readable indicia comprises data indicating at least one of a current date, a current time, a placement location of the readable indicia within the advertisement, a visual characteristic of the readable indicia, or a time elapsed since inception of the advertisement.

13. The method of claim 9, wherein the readable indicia comprises data indicating at least one of a current date, a time of inception of the advertisement, a placement location of the readable indicia within the advertisement, or a visual characteristic of the readable indicia.

14. The method of claim 9, wherein the computing program code is further to cause the processor to determine a value of a characteristic that maximizes user selection of the readable indicia.

15. The method of claim 9, wherein the computing program code is further to cause the processor to determine a combination of values of a plurality of characteristics that maximize user selection of the readable indicia.

16. The method of claim 9, wherein the readable indicia comprises a vanishing readable indicia that presents a continuously diminishing time remaining communication, wherein when the time remaining communication reaches zero, the vanishing readable indicia is removed from the advertisement.

17. A computer program product for processing readable indicia for a payment claim, the computer program product comprising:
a non-transitory computer-readable medium comprising a set of codes for causing a computer to:
present a readable indicia in association with an advertisement, wherein the readable indicia includes instructions for triggering a data collection tool;
collect data from the data collection tool; and
analyze characteristics of the readable indicia and the advertisement in order to determine a customer advertisement impact.

18. The computer program product of claim 17, wherein the readable indicia comprises a Quick Response (QR) code.

19. The computer program product of claim 17, wherein the readable indicia comprises a variable readable indicia.

20. The computer program product of claim 19, wherein the variable readable indicia comprises data indicating at least one of a current date, a current time, a placement location of the readable indicia within the advertisement, a visual characteristic of the readable indicia, or a time elapsed since inception of the advertisement.

21. The computer program product of claim 17, the readable indicia comprises data indicating at least one of a current date, a time of inception of the advertisement, a placement location of the readable indicia within the advertisement, or a visual characteristic of the readable indicia.

22. The computer program product of claim 17, wherein the set of codes is further for causing the computer to determine a value of a characteristic that maximizes user selection of the readable indicia.

23. The computer program product of claim 17, wherein the set of codes is further for causing the computer to determine a combination of values of a plurality of characteristics that maximize user selection of the readable indicia.

24. The computer program product of claim 17, wherein the readable indicia comprises a vanishing readable indicia that presents a continuously diminishing time remaining communication, wherein when the time remaining communication reaches zero, the vanishing readable indicia is removed from the advertisement.
